(19) United States
(12) Patent Application Publication
(10) Pub. No.: US 2020/0262553 A1
(43) Pub. Date: Aug. 20, 2020

(54) HYBRID ELECTRIC-JET POWERED

(71) Applicant: Roberto Gomez, Woodland Park, NJ (US)

(72) Inventor: Roberto Gomez, Woodland Park, NJ (US)

(21) Appl. No.: 16/846,364

(22) Filed: Apr. 12, 2020

Related U.S. Application Data
(60) Provisional application No. 62/806,905, filed on Feb. 18, 2019.

(51) Int. Cl. B64C 29/00; B64D 27/02; B64D 47/08

(52) U.S. Cl. CPC B64C 29/0033; B64D 27/02; B64D 17/72; B64D 2027/026; B64D 47/08

(57) ABSTRACT

A hybrid electric jet powered aircraft including a fuselage member, a power unit, a set of wing members, and an emergency safety unit. The fuselage member includes a cabin having a plurality of enclosed seating elements for transporting a plurality of passengers and a cockpit having a plurality of seating elements for one or more operators of the aircraft. The power unit includes at least one electric powered motor and at least one jet fueled powered engine. The set of wing members for lifting the fuselage member. The set includes two pairs of wing members, wherein each pair of wing members is attached at its proximate end to the fuselage member on opposite sides of the fuselage member from one another. Each wing member has a tilting ducted fan attached to its distal end. Each ducted fan is tilted in a first position for horizontal forward flight and each ducted fan is tilted in a second position for vertical flight. The emergency safety unit for ejecting a parachute canopy when an emergency situation occurs in the aircraft.

### CROSS-REFERENCE TO RELATED APPLICATION

This application claims the benefit of priority of U.S. Provisional Application No. 62/806,905 filed on Feb. 18, 2019, the disclosure of which is incorporated herein by reference in its entirety.

### FIELD OF THE INVENTION

Embodiments described herein generally relate to aircrafts, and more particularly to a hybrid electric jet powered aircraft.

### BACKGROUND OF THE INVENTION

Current commercial passenger aircrafts are not powered with hybrid electric and jet power. Electric/Jet powered aircrafts will cause less emissions and due to propeller enclosure, less air will be displaced which allows for operation of the aircraft in tight urban areas. Hence it is desirable to provide a hybrid electric-jet powered commercial passenger aircraft.

### BRIEF DESCRIPTION OF THE DRAWINGS

The various advantages of the embodiments of the present disclosure will become apparent to one skilled in the art by reading the following specification and appended claims, and by referencing the following drawings, in which:

FIG. 1 shows an exemplary view of a hybrid electric-jet powered aircraft according to an embodiment of the present disclosure.

FIG. 2 shows another exemplary view a hybrid electric-jet powered aircraft according to an embodiment of the present disclosure.

FIG. 3 shows an exploded view of a camera and landing gear in the hybrid electric jet powered aircraft according to an embodiment of the present disclosure.

FIG. 4 shows an exemplary view of a cabin region in the hybrid electric-jet powered aircraft according to an embodiment of the present disclosure.

### SUMMARY OF THE INVENTION

Exemplary embodiments disclosed herein describe a hybrid electric-jet powered aircraft. The hybrid electric-jet powered aircraft includes a fuselage member, a power unit, a set of wing members, a twin tail and an emergency safety unit. The fuselage member includes a cabin having a plurality of enclosed seating elements for transporting a plurality of passengers and a cockpit having a plurality of seating elements for one or more operators of the aircraft. The power unit includes at least one electric powered motor and at least one jet fueled powered engine. The set of wing members for lifting the fuselage member. The set includes two pairs of wing members, wherein each pair of wing members is attached at its proximate end to the fuselage member on opposite sides of the fuselage member from one another. Each wing member has a tilting ducted fan attached to its distal end. Each ducted fan is tilted in a first position for horizontal forward flight and each ducted fan is tilted in a second position for vertical flight. The emergency safety unit for ejecting a parachute canopy when an emergency situation occurs in the aircraft.

In some exemplary embodiments, the aircraft includes a twin tail assembly attached to a rear end of the fuselage member for stabilizing the aircraft.

In some exemplary embodiments, the emergency safety unit is a ballistic parachute system.

In some exemplary embodiments, in the first position, each ducted fan is in a parallel horizontal position relative to the corresponding attached wing member.

In some exemplary embodiments, in the second position, each ducted fan is in a perpendicular vertical position relative to the corresponding attached wing member.

In some exemplary embodiments, the cabin is void of physical windows.

In some exemplary embodiments, the aircraft includes a plurality of camera, and each camera is externally mounted at different locations on the aircraft.

In some exemplary embodiments, each cabin has a plurality of virtual visual aids.

In some exemplary embodiments, the plurality of visual aids are organic light-emitting diode (OLED) displays, each providing passengers with a visual reference of the aircraft's exterior based on information observed by the plurality of externally mounted cameras.

In some exemplary embodiments, each ducted fan is attached to a tip of a corresponding wing member.

### DETAILED DESCRIPTION

The present disclosure describes a hybrid electric jet powered aircraft (“the aircraft”). The aircraft is a hybrid jet fuel/electric powered air vehicle for transporting passengers to and from their destinations. The hybrid aircraft causes less emissions and the propeller enclosure causes less displaced air which allows for operations in tight urban area. The aircraft is configured to transition from vertical flight to forward flight and is configured to operate in all weather conditions.

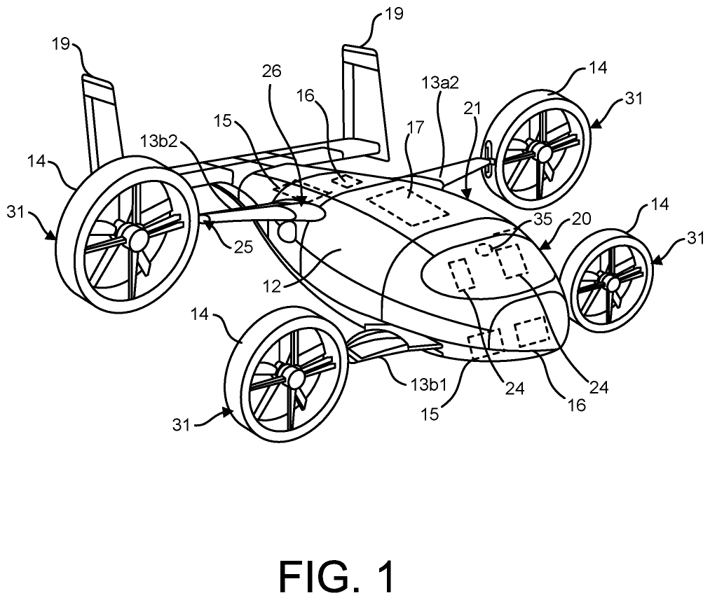

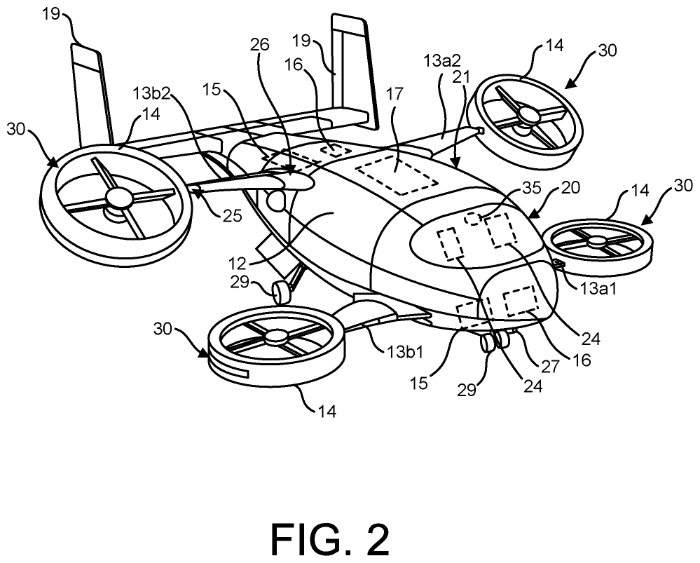

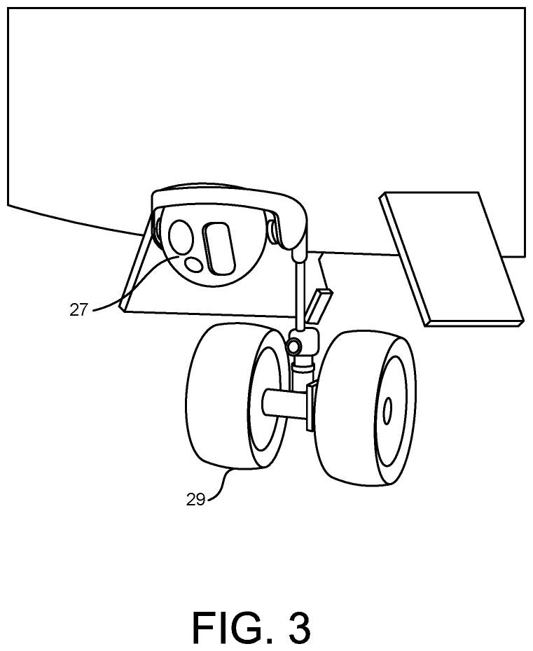

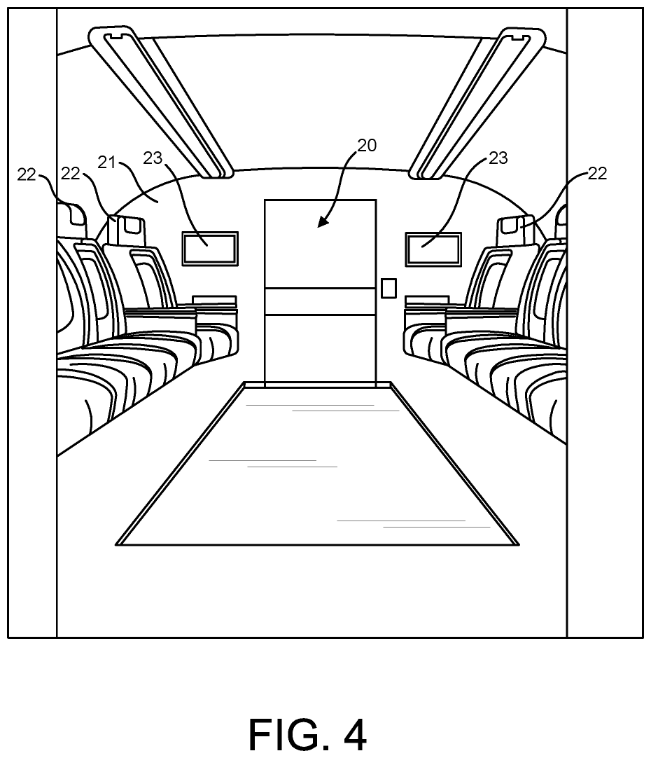

As illustrated in FIGS. 1-4, the aircraft 10 includes a fuselage member 12, a set of wing members 13 (i.e., 13a, 13b), a power unit (15, 16), a twin tail assembly 19, an emergency safety unit 17, at least one camera 27, and landing gear 29. The aircraft 10 may be made from any suitable material capable of keeping the maximum take-off weight below 15,000 lbs. The aircraft 10 may be configured as any suitable size. In a preferred embodiment, the aircraft may have a length of forty-one feet and a wingspan of forty-nine feet.

The fuselage member 12 is the body of the aircraft to which the external parts of the aircraft are connected (e.g., wings, tail, camera, etc.). The interior of the fuselage includes a cabin 21 and a cockpit 20. The cabin may have a plurality of seating elements 22 for transporting passengers. Likewise, the cockpit may have a plurality of seating elements 24 for seating operators of the aircraft. In a preferred embodiment, the cabin may be configured to seat up to ten passengers and the cockpit 20 may be configured to seat up to two aircraft operators (e.g., pilots). In addition, the cockpit houses the controls for operating the aircraft.

The cockpit 20 may be configured as a glass cockpit. Specifically, the cockpit may be configured with features such as, for example, electronic (i.e., digital) flight instrument displays, large LCD screens, etc., rather than the traditional style of analog dials and gauges. The benefits of flying with a glass cockpit are situational awareness is increased, decreased fuel flow in order to compensate for decreased air density, reduced rate of climb and increased airspeed.

The cabin 21 may not include any physical windows. Rather, the cabin may include at least one virtual visual aid 23. The at least one virtual visual aid provides the passengers in the cabin with a visual reference of the aircraft's exterior based on information observed by the at least one externally mounted camera 27. In a preferred embodiment, the aircraft 10 includes a plurality of externally mounted cameras 27 which are each mounted in a different location of the aircraft to offer passengers a real-time view outside the aircraft. The cameras 27 may be high resolution devices which offer a very clear, wide view of the outside. The at least one virtual visual aid may include an organic light-emitting diode (OLED) display. In a preferred embodiment, the cabin includes a plurality of virtual visual aids (i.e., OLED displays).

The power unit includes a hybrid combination of at least one electric powered motor 15 and at least one jet fueled (e.g., JET-A) powered engine 16. This feature gives the aircraft the advantage of mechanical efficiency and proven reliability. The jet engine is powered by jet fuel and the jet engine is then used to operate the electric motor. The electric motor 15 powers the ducted fans. Moreover, the electric motor 15 creates energy to be consumed by the aircraft's systems and rotors. Subsequently, energy may be stored on-board the aircraft 10 with the use of batteries. Energy may also be produced by the rotors spinning inside the ducted fan and this energy may be used to power systems or may be stored in batteries.

In a preferred embodiment, the aircraft 10 may house two electric motors 15, two jet engines 16, multiple generators, multiple batteries and four ducted fans 14. One electric motor 15 and one jet engine may be installed in the front of the aircraft to power the ducted positioned near the cockpit. The front-end electric motor 15 may be mechanically coupled to the front-end jet engine 16 and the front-end ducted fans 13a, 13b. The other electric motor 15 and jet engine may be installed in the rear of the aircraft to power the ducted fans 14 near the tail of the aircraft. The rear-end electric motor 15 may be mechanically coupled to the rear-end jet engine 16 and the rear-end ducted fans 13a, 13b.

The set of wing members 13a and 13b provide the lift for the aircraft 10. The set of wing members includes two pairs of wing members (i.e., 13a and 13b). Each pair includes a front wing member (i.e., 13a1, 13b1 respectively) and each pair includes a rear wing member (i.e., 13a2 and 13b2 respectively). Moreover, each pair of wing members is attached at its proximate end 26 to the fuselage member 12 on opposite sides from one another. So, for example, pair 1 (i.e., 13a1, 13a2) may be installed on the right side of the fuselage member 12 and pair 2 (i.e., 13b1, 13b2) may be installed on the left side of the fuselage member 12.

In addition, each wing member 13 has a ducted fan 14 installed at its distal end 25 (i.e., wing tip). The ducted fans 14 each include a rotor which rotates inside each duct. The aircraft's lift is produced by the rotors. Each rotor can rotate inside each corresponding duct. The aircraft 10 may include any number of rotors. In a preferred embodiment, the aircraft 10 is a quad rotor system (i.e., the aircraft has four rotors). The ducted fans may be configured as any suitable size. In a preferred embodiment, the ducted fans attached to the rear wing members (i.e., 13a2 and 13b2) may have a size larger than the ducted fans attached to the front wing members (i.e., 13a1 and 13b1). Moreover, the rotors may be configured as any suitable size. In one aspect, the ducted fans may include small rotors which provide reduced vibration and noise.

Each ducted fan may include tilting functionality, that is, the angle position of each ducted fan relative to the position of the corresponding wing member 13 to which the ducted fan is attached may be changed to different angles. In other words, the position of the ducted fans is not fixed nor stationary. Rather, the position of the ducted fans may change dynamically depending upon the desired type (e.g., direction) of air flight. So, for example, each ducted fan 14 may be tilted in a first position for horizontal forward flight and each ducted fan may be tilted in a second position for vertical flight. In horizontal flight, such as, for example, forward flight, cruising, the first position of each ducted fan may be a parallel horizontal position 30 relative to the corresponding attached wing member 13. In vertical flight, such as, for example, vertical takeoff and landing (VTOL), short takeoff and hovering, the second position of each ducted fan 14 may be a perpendicular vertical position 31 relative to the corresponding attached wing member 13.

The aircraft 10 includes an emergency safety unit 17 for ejecting a parachute canopy when an emergency situation (e.g., engine loss, power failure) occurs. The emergency safety unit may include a ballistic parachute system (B.P.S.). The pilot may deploy the B.P.S by pulling a handle 35 located in the cockpit 20. An activation cable may lead to an igniter that fires a rocket motor to extract the parachute, which is usually in the rear of the aircraft. The rocket accelerates and the aircraft pitches up as the rocket extracts the parachute. The parachute may be housed in a softpack, fiberglass box, or aluminum canister. Thereafter, the parachute canopy inflates, and the aircraft begins to decelerate. Once it stabilizes under the canopy, the airplane descends.

The aircraft 10 may include a twin tail assembly 19 attached to a rear end of the fuselage member 12. The twin tail assembly stabilizes flight and landing of the aircraft. Moreover, the aircraft may include landing gear 29 which provides a suspension system during taxi, take-off and landing. The landing gear is designed to absorb and dissipate the kinetic energy of landing impact, thereby reducing the impact loads transmitted to the fuselage 12.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed:

1. A hybrid electric-jet powered aircraft comprising:
a fuselage member including a cabin having a plurality of enclosed seating elements for transporting a plurality of passengers and a cockpit having a plurality of seating elements for one or more operators of the aircraft;
a power unit including at least one electric powered motor and at least one jet fueled powered engine;
a set of wing members for lifting the fuselage member, the set including two pairs of wing members, wherein each pair of wing members is attached at its proximate end to the fuselage member on opposite sides of the fuselage member from one another, each wing member having a tilting ducted fan attached to its distal end, wherein each ducted fan is tilted in a first position for horizontal forward flight and each ducted fan is tilted in a second position for vertical flight; and
an emergency safety unit for ejecting a parachute canopy when an emergency situation occurs in the aircraft.

2. The aircraft of claim 1, further comprising a twin tail assembly attached to a rear end of the fuselage member for stabilizing the aircraft.

3. The aircraft of claim 1, wherein the emergency safety unit is a ballistic parachute system.

4. The aircraft of claim 1, wherein in the first position, each ducted fan is in a parallel horizontal position relative to the corresponding attached wing member.

5. The aircraft of claim 1, wherein in the second position, each ducted fan is in a perpendicular vertical position relative to the corresponding attached wing member.

6. The aircraft of claim 1, wherein the cabin is void of physical windows.

7. The aircraft of claim 1, further comprising a plurality of cameras, wherein each camera is externally mounted at different locations on the aircraft.

8. The aircraft of claim 7, wherein the cabin has a plurality of virtual visual aids.

9. The aircraft of claim 8, wherein the plurality of visual aids are organic light-emitting diode (OLED) displays, each providing passengers with a visual reference of the aircraft's exterior based on information observed by the plurality of externally mounted cameras.

10. The aircraft of claim 1, wherein each ducted fan is attached to a tip of a corresponding wing member.
